(19) United States
(12) Patent Application Publication
(10) Pub. No.: US 2018/0160386 A1
(43) Pub. Date: Jun. 7, 2018

(54) EFFECTIVE SCANNING SOLUTION DURING MULTI-SIM ROAMING

(71) Applicant: QUALCOMM Incorporated, San Diego, CA (US)

(72) Inventors: Bhaskaran ARUMUGAM, Hyderabad (IN); Sai Lokesh LADHAGIRI KRISHNAKUMAR, Hyderabad (IN); Manjunatha Subbamma ANANDA, Hyderabad (IN)

(21) Appl. No.: 15/368,183

(22) Filed: Dec. 2, 2016

(51) Int. Cl. H04W 60/00; H04L 29/06; H04W 72/04

(52) U.S. Cl. CPC H04W 60/005; H04L 63/0853; H04W 84/042; H04W 72/048; H04L 69/28

(57) ABSTRACT

A method for home public land mobile network (HPLMN) search during roaming for a multi-subscriber identity module (SIM) mobile communication device, may include: determining that a first subscription and a second subscription are roaming; determining whether an HPLMN search timer has expired for the first subscription; in response to determining that the HPLMN search timer has expired for the first subscription, determining whether a mode capability of the first subscription is greater than a mode capability of the second subscription; and in response to determining that the mode capability of the first subscription is greater than the mode capability of the second subscription, performing an HPLMN search for the first subscription.

### BACKGROUND

In a multi-subscriber identity module (SIM) device, when two SIMs are roaming a search for a home public land mobile network (HPLMN) is done separately based on based on expiration of an HPLMN search timer. Previously, support for a radio access technology (RAT) on one SIM was restricted to global system for mobile communications (GSM). Currently, H PLMN search for the two SIMs is extended to additional RATs, for example, long term evolution (LTE), wideband code division multiple access (WCDMA) and GSM.

The time taken to complete the H PLMN search for the RATs on one SIM affects the parallel H PLMN search started by another SIM. The problem is even more difficult in case of multi-SIM multi-standby (MSMS) mobile communication devices where only one radio frequency (RF) chain is shared between subscriptions.

### SUMMARY

Apparatuses and methods for HPLMN search during roaming for a multi-SIM mobile communication device are provided.

According to various aspects there is provided a method for home public land mobile network (HPLMN) search during roaming for a multi-subscriber identity module (SIM) mobile communication device. In some aspects, the method may include: determining that a first subscription and a second subscription are roaming; determining whether an HPLMN search timer has expired for the first subscription; in response to determining that the HPLMN search timer has expired for the first subscription, determining whether a mode capability of the first subscription is greater than a mode capability of the second subscription; and in response to determining that the mode capability of the first subscription is greater than the mode capability of the second subscription, performing an HPLMN search for the first subscription.

According to various aspects there is provided a multi-subscriber identity module (SIM) mobile communication device. In some aspects, the multi-SIM mobile communication device may include: a communication unit configured to communicate with one or more communication networks; a memory operably connected to the communication unit; a timing unit configured to implement an HPLMN search timer; and a control unit operably connected to the communication unit, the memory, and the timing unit.

The control unit may be configured to: determine that a first subscription and a second subscription are roaming; monitor the HPLMN search timer to determine whether the HPLMN search timer has expired for the first subscription; in response to determining that the HPLMN search timer has expired for the first subscription, determine whether a mode capability of the first subscription is greater than a mode capability of the second subscription; and in response to determining that the mode capability of the first subscription is greater than the mode capability of the second subscription, control the communication unit to perform an HPLMN search for the first subscription.

According to various aspects there is provided a non-transitory computer readable medium. In some aspects, the non-transitory computer readable medium may include instructions for causing one or more processors to perform operations including: determining that a first subscription and a second subscription are roaming; determining whether an HPLMN search timer has expired for the first subscription; in response to determining that the HPLMN search timer has expired for the first subscription, determining whether a mode capability of the first subscription is greater than a mode capability of the second subscription; in response to determining that the mode capability of the first subscription is greater than the mode capability of the second subscription, performing an HPLMN search for the first subscription; and utilizing results of the HPLMN search for the first subscription to identify an HPLMN for the second subscription.

According to various aspects there is provided a multi-subscriber identity module (SIM) mobile communication device. In some aspects, the multi-SIM mobile communication device may include: means for determining that a first subscription and a second subscription are roaming; means for determining whether an HPLMN search timer has expired for the first subscription; in response to determining that the HPLMN search timer has expired for the first subscription, means for determining whether a mode capability of the first subscription is greater than a mode capability of the second subscription; in response to determining that the mode capability of the first subscription is greater than the mode capability of the second subscription, means for performing an HPLMN search for the first subscription; and means for utilizing results of the HPLMN search for the first subscription to identify an HPLMN for the second subscription.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various aspects of the present disclosure;

FIG. 1B is a diagram illustrating a network environment for various aspects of the present disclosure; and

FIG. 2 is illustrating a method for HPLMN search during roaming for a multi-SIM mobile communication device according to various aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

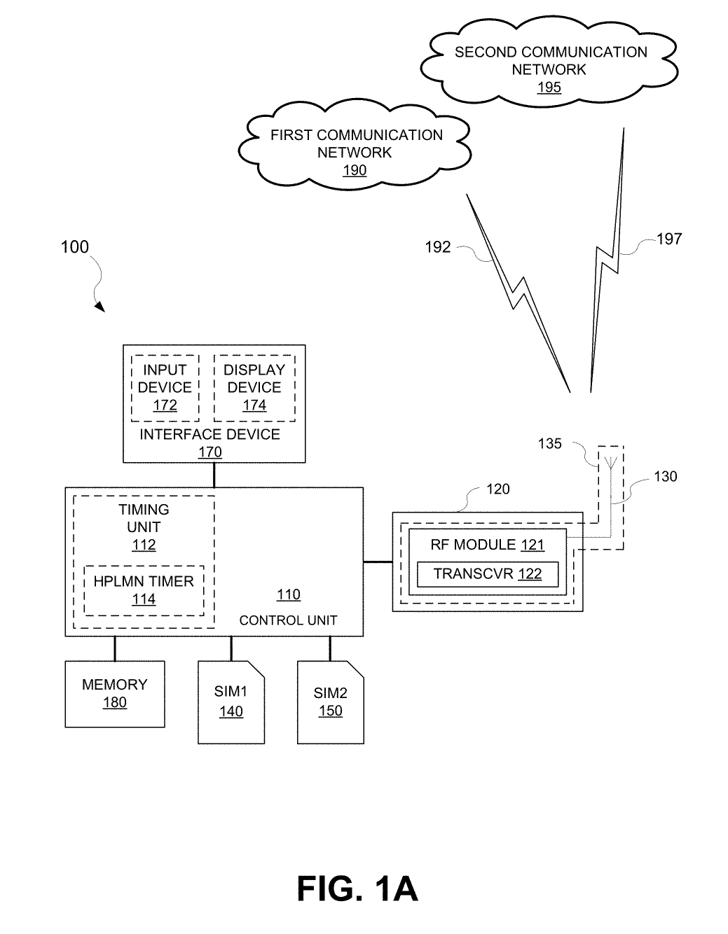

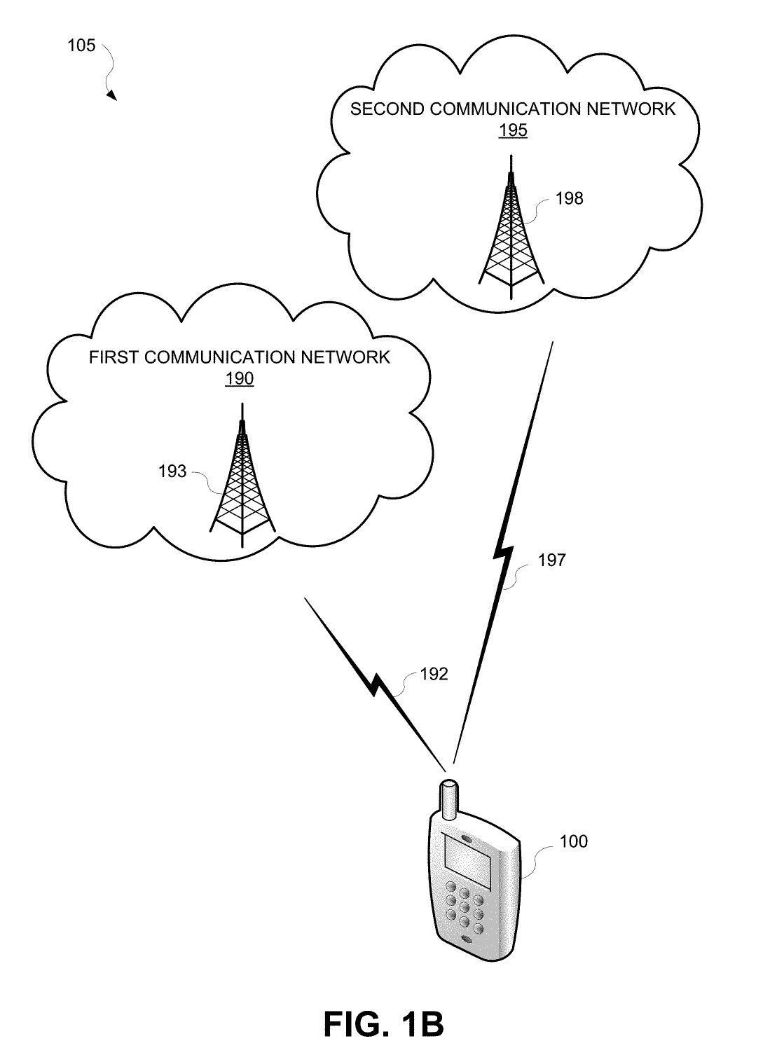

FIG. 1A is a block diagram illustrating a mobile communication device 100 according to various embodiments. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, an RF module 121. The RF module 121 may include, for example, but not limited to a transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 may receive and transmit signals on the active RAT. When a RAT is idle, the communication unit 120 may receive but does not transmit signals on the idle RAT.

For convenience, the various embodiments are described in terms of dual-SIM dual-standby (DSDS) mobile communication devices. However, one of ordinary skill in the art will appreciate that the various embodiments may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, WCDMA, and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The control unit 110 may include a timing unit 112 configured to provide one or more timers, for example, but not limited to, an HPLMN search timer 114. The HPLMN search timer 114 may include a plurality of HPLMN timers for a plurality of subscriptions. Alternatively, the timing unit 112, and the HPLMN search timer 114 may be implemented as electronic circuitry separate from the control unit 110.

The memory 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

A multi-SIM mobile communication device (e.g., the mobile communication device 100) may select and register on an HPLMN other than the HPLMN of the mobile communication device 100 if roaming is permitted. When registered on a PLMN other than an HPLMN the multi-SIM mobile communication device 100 may periodically attempt to obtain service on an HPLMN for at least one subscription based on the expiration of an HPLMN search timer (e.g., the HPLMN search timer 114) for that subscription. An initial value for the HPLMN search timer 114, for example a value in the range of 2-30 minutes or some other range, may be set. The initial value for the HPLMN search timer 114 may be stored in the mobile communication device 100, for example, in the memory 180, or in internal storage of the control unit 110.

In accordance with certain aspects of the disclosure, when two or more subscriptions (e.g., Sub1 192 and Sub2 197) are roaming, an HPLMN search for only the subscription having a mode preference that is a super set of the other subscription may be performed when the HPLMN search timer 114 expires. For example, if Sub1 192 includes LTE, W CDMA, and GSM RATs, and Sub2 197 includes W CDMA and GSM RATs, the mode preference of Sub1 192 is a super set of the mode preference of Sub2 197. Accordingly, an HPLMN search may be performed for Sub1 192. If both the subscription are of the same mode preference (i.e., the subscriptions include the same RATs), then the HPLMN search may be performed on the subscription for which data is enabled.

During the HPLMN search for Sub1 192, an HPLMN for Sub2 197 may also be detected. Alternatively or additionally, preferred PLMNs for Sub1 192 and/or Sub2 197 may be detected. HPLMNs may not be the same for different RATs and/or different subscriptions. Once the results of the HPLMN search for Sub1 192 are available, the same HPLMN search results may be utilized for Sub2 197. The non-access stratum (NAS) layer of the mobile communication device 100 looks for the availability of the HPLMN for both the subscriptions whenever HPLMN search results are available. If an HPLMN for Sub1 192 is detected before an HPLMN for Sub2 197 is detected Sub1 192 may camp on the HPLMN and will no longer be roaming. Sub2 197 may then perform a conventional HPLMN search.

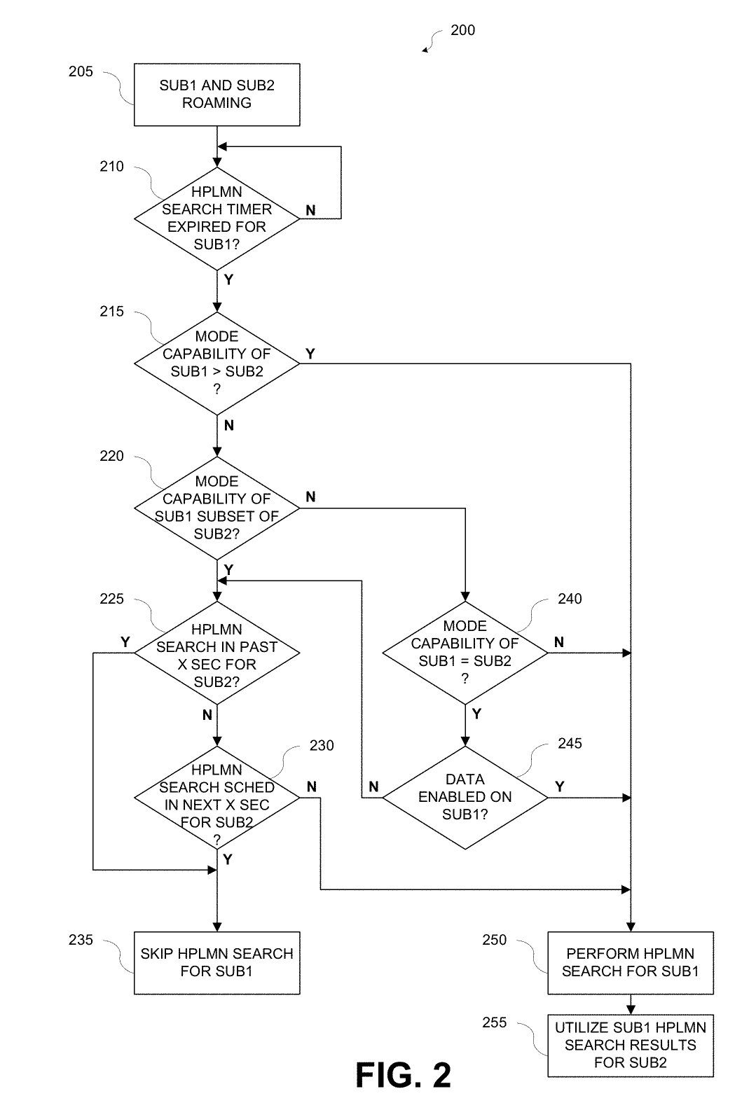

FIG. 2 is a flowchart illustrating a method 200 for HPLMN search during roaming for a multi-SIM mobile communication device in accordance with certain aspects of the present disclosure. Referring to FIG. 2, at block 205 the first subscription Sub1 192 and the second subscription Sub2 197 may be roaming. At block 210 it may be determined whether the HPLMN search timer (e.g., the HPLMN search timer 114) for Sub1 192 has expired. For example, the control unit 110 may monitor the HPLMN search timer 114 and determine whether the HPLMN search timer 114 has reached a stored value (e.g., a value in the range of 2-30 minutes or some other range) for expiration of the HPLMN search timer 114 for Sub1 192. In response to determining that the HPLMN search timer 114 has not expired (210-N), the control unit 110 may cause the method to continue at operation 210.

In response to determining that the HPLMN search timer 114 for Sub1 192 has expired (210-Y), at block 215 it may be determined whether the mode capability (i.e., the number of RATs) of Sub1 192 is greater than the mode capability of Sub2 197. For example, the control unit 110 may determine whether the number of RATs associated with Sub1 192 is greater than the number of RATs associated with Sub2 197. The number and type (e.g., LTE, GSM, etc.) of RATs associated with Sub1 192 and Sub2 197 may be stored in the memory 180 and/or internal memory of the control unit 110.

In response to determining that the mode capability of Sub1 192 is greater than the mode capability of Sub2 197 (215-Y), at block 250 an HPLMN search for Sub1 192 may be performed. For example, the control unit 110 may control the communication unit 120 to search for frequencies of the RATs associated with Sub1 192. At block 255, the HPLMN search results for Sub1 192 may be utilized for Sub2 197. For example, during the HPLMN search for Sub1 192, an HPLMN for Sub2 197 may also be detected. Alternatively or additionally, preferred PLMNs for Sub1 192 and/or Sub2 197 may be detected. The control unit 110 may cause the communication unit 120 to camp on an HPLMN or a preferred PLMN for Sub2 197 based on the HPLMN search results for Sub1 192.

HPLMNs may not be the same for different RATs and/or different subscriptions. Once the results of the HPLMN search for Sub1 192 are available, the same HPLMN search results may be utilized for Sub2 197. The non-access stratum (NAS) layer of the mobile communication device 100 looks for the availability of the HPLMN for both the subscriptions whenever HPLMN search results are available. If an HPLMN for Sub1 192 is detected before an HPLMN for Sub2 197 is detected Sub1 192 may camp on the HPLMN and will no longer be roaming. Sub2 197 may then perform a conventional HPLMN search. If only preferred PLMNs are detected for Sub1 192 and/or Sub2 197, Sub1 192 and/or Sub2 197 may camp on a preferred PLMN.

In response to determining that the mode capability of Sub1 192 is not greater than the mode capability of Sub2 197 (215-N), at block 220 it may be determined whether the mode capability of Sub1 192 is a subset of the mode capability of Sub2 197. For example, the control unit 110 may determine whether the RATs associated with Sub1 192 are included in a larger number of RATs associated with Sub2 197.

In response to determining that the mode capability of Sub1 192 is a subset of the mode capability of Sub2 197 (220-Y), at block 225 it may be determined whether an HPLMN search was performed for the second subscription (i.e., Sub2 197) within a previously predetermined time period, for example, 30 seconds or some other time period. For example, the control unit 110 may determine whether the control unit 110 performed an HPLMN search for Sub2 197 within the previous 30 seconds or some other time period.

In response to determining that an HPLMN search was performed for the second subscription (i.e., Sub2 197) within the previously predetermined time period (225-Y), at block 235 the HPLMN search for Sub1 192 may be skipped. For example, the control unit 110 may control the communication unit 120 to prevent the communication unit 120 from performing an HPLMN search for either subscription.

In response to determining that an HPLMN search was not performed for either subscription within the previously predetermined time period (225-N), at block 230 it may be determined whether an HPLMN search is scheduled to be performed for the second subscription (i.e., Sub2 197) within a next predetermined time period, for example, 30 seconds or some other time period. For example, the control unit 110 may determine whether the communication unit 120 is scheduled to perform an HPLMN search for Sub2 197 within the next 30 seconds or some other time period.

In response to determining that an HPLMN search is scheduled to be performed for the second subscription within the next predetermined time period (230-Y), at block 235 the HPLMN search for Sub1 192 may be skipped. In response to determining that an HPLMN search is not scheduled to be performed for the second subscription within a next predetermined time period (230-N), at block 250 an HPLMN search for Sub1 192 may be performed. For example, the control unit 110 may control the communication unit 120 to search for frequencies of the RATs associated with Sub1 192.

At block 255, the HPLMN search results for Sub1 192 may be utilized for Sub2 197. For example, during the HPLMN search for Sub1 192, an HPLMN for Sub2 197 may also be detected. Alternatively or additionally, preferred PLMNs for Sub1 192 and/or Sub2 197 may be detected. The control unit 110 may cause the communication unit 120 to camp on an HPLMN for Sub2 197 based on the HPLMN search results for Sub1 192.

Returning to block 220, in response to determining that the mode capability of Sub1 192 is a subset of the mode capability of Sub2 197 (220-N), at block 240 it may be determined whether the mode capability of Sub1 192 is equal to the mode capability of Sub2 197. For example, the control unit 110 may determine whether the RATs associated with Sub1 192 are the same RATs associated with Sub2 197. In response to determining that the mode capability of Sub1 192 is not equal to the mode capability of Sub2 197 (240-N), at block 250 an HPLMN search for Sub1 192 may be performed. For example, the control unit 110 may control the communication unit 120 to search for frequencies of the RATs associated with Sub1 192.

At block 255, the HPLMN search results for Sub1 192 may be utilized for Sub2 197. For example, during the HPLMN search for Sub1 192, an HPLMN for Sub2 197 may also be detected. Alternatively or additionally, preferred PLMNs for Sub1 192 and/or Sub2 197 may be detected. The control unit 110 may cause the communication unit 120 to camp on an HPLMN for Sub2 197 based on the HPLMN search results for Sub1 192.

In response to determining that the mode capability of Sub1 192 is equal to the mode capability of Sub2 197 (240-Y), at block 245 it may be determined whether data is enabled on Sub1 192. For example, the control unit 110 may determine whether Sub1 192 is configured is the dedicated data subscription (DDS). In response to determining that data is not enabled on Sub1 192 (245-N), the control unit 110 may cause the method to continue at operation 225.

In response to determining that data is enabled on Sub1 192 (245-Y), at block 250 an HPLMN search for Sub1 192 may be performed. For example, the control unit 110 may control the communication unit 120 to search for frequencies of the RATs associated with Sub1 192. At block 255, the HPLMN search results for Sub1 192 may be utilized for Sub2 197. For example, during the HPLMN search for Sub1 192, an HPLMN for Sub2 197 may also be detected. Alternatively or additionally, preferred PLMNs for Sub1 192 and/or Sub2 197 may be detected. The control unit 110 may cause the communication unit 120 to camp on an HPLMN for Sub2 197 based on the HPLMN search results for Sub1 192.

While the above method was described in terms of expiration of the HPLMN search timer for Sub1, one of ordinary skill in the art will appreciate that similar operations may be performed based on the expiration of the HPLMN search timer for Sub2 without departing from the scope of the present disclosure.

The methods 200 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for home public land mobile network (HPLMN) search during roaming for a multi-subscriber identity module (SIM) mobile communication device, the method comprising:
determining that a first subscription and a second subscription are roaming;
determining whether an HPLMN search timer has expired for the first subscription;
in response to determining that the HPLMN search timer has expired for the first subscription, determining whether a mode capability of the first subscription is greater than a mode capability of the second subscription; and
in response to determining that the mode capability of the first subscription is greater than the mode capability of the second subscription, performing an HPLMN search for the first subscription.

2. The method of claim 1, further comprising:
in response to determining that the mode capability of the first subscription is not greater than the mode capability of the second subscription, determining whether the mode capability of the first subscription is a subset of the mode capability of the second subscription;
in response to determining that the mode capability of the first subscription is not a subset of the mode capability of the second subscription, determining whether the mode capability of the first subscription is equal to the mode capability of the second subscription; and
in response to determining that the mode capability of the first subscription is not equal to the mode capability of the second subscription, performing the HPLMN search for the first subscription.

3. The method of claim 2, further comprising:
in response to determining that the mode capability of the first subscription is equal to the mode capability of the second subscription, determining whether data is enabled on the first subscription; and
in response to determining the data is enabled on the first subscription, performing the HPLMN search for the first subscription.

4. The method of claim 3, further comprising:
in response to determining the data is not enabled on the first subscription, determining whether an HPLMN search for the second subscription was performed within a previous predetermined time period; and
in response to determining that an HPLMN search for the second subscription was performed within the previous predetermined time period, skipping performing the HPLMN search for the first subscription.

5. The method of claim 4, further comprising:
in response to determining that an HPLMN search for the second subscription was not performed within the previous predetermined time period, determining whether an HPLMN search for the second subscription is scheduled to be performed within a subsequent predetermined time period; and
in response to determining that an HPLMN search for the second subscription is not scheduled to be performed within the subsequent predetermined time period, performing the HPLMN search for the first subscription.

6. The method of claim 5, further comprising:
in response to determining that an HPLMN search for the second subscription is scheduled to be performed within the subsequent predetermined time period, skipping performing the HPLMN search for the first subscription.

7. The method of claim 2, further comprising:
in response to determining that the mode capability of the first subscription is a subset of the mode capability of the second subscription, determining whether an HPLMN search for the second subscription was performed within a previous predetermined time period; and
in response to determining that an HPLMN search for the second subscription was performed within the previous predetermined time period, skipping performing the HPLMN search for the first subscription.

8. The method of claim 7, further comprising:
in response to determining that an HPLMN search for the second subscription was not performed within the previous predetermined time period, determining whether an HPLMN search for the second subscription is scheduled to be performed within a subsequent predetermined time period; and
in response to determining that an HPLMN search for the second subscription is not scheduled to be performed within the subsequent predetermined time period, performing the HPLMN search for the first subscription.

9. The method of claim 8, further comprising:
in response to determining that an HPLMN search for the second subscription is scheduled to be performed within the subsequent predetermined time period, skipping performing the HPLMN search for the first subscription.

10. The method of claim 1, further comprising:
utilizing results of the HPLMN search for the first subscription to identify an HPLMN for the second subscription.

11. A multi-subscriber identity module (SIM) mobile communication device, comprising:
a communication unit configured to communicate with one or more communication networks;
a memory operably connected to the communication unit;
a timing unit configured to implement an HPLMN search timer; and
a control unit operably connected to the communication unit, the memory, and the timing unit, the control unit configured to:
determine that a first subscription and a second subscription are roaming;
monitor the HPLMN search timer to determine whether the HPLMN search timer has expired for the first subscription;
in response to determining that the HPLMN search timer has expired for the first subscription, determine whether a mode capability of the first subscription is greater than a mode capability of the second subscription; and
in response to determining that the mode capability of the first subscription is greater than the mode capability of the second subscription, control the communication unit to perform an HPLMN search for the first subscription.

12. The multi-SIM mobile communication device of claim 11, wherein the control unit is further configured to:
in response to determining that the mode capability of the first subscription is not greater than the mode capability of the second subscription, determine whether the mode capability of the first subscription is a subset of the mode capability of the second subscription;
in response to determining that the mode capability of the first subscription is not a subset of the mode capability of the second subscription, determine whether the mode capability of the first subscription is equal to the mode capability of the second subscription; and
in response to determining that the mode capability of the first subscription is not equal to the mode capability of the second subscription, control the communication unit to perform the HPLMN search for the first subscription.

13. The multi-SIM mobile communication device of claim 12, wherein the control unit is further configured to:
in response to determining that the mode capability of the first subscription is equal to the mode capability of the second subscription, determine whether data is enabled on the first subscription; and
in response to determining the data is enabled on the first subscription, control the communication unit to perform the HPLMN search for the first subscription.

14. The multi-SIM mobile communication device of claim 13, wherein the control unit is further configured to:
in response to determining the data is not enabled on the first subscription, determine whether an HPLMN search for the second subscription was performed within a previous predetermined time period; and
in response to determining that an HPLMN search for the second subscription was performed within the previous predetermined time period, control the communication unit to skip performing the HPLMN search for the first subscription.

15. The multi-SIM mobile communication device of claim 14, wherein the control unit is further configured to:
in response to determining that an HPLMN search for the second subscription was not performed within the previous predetermined time period, determine whether an HPLMN search for the second subscription is scheduled to be performed within a subsequent predetermined time period; and
in response to determining that an HPLMN search for the second subscription is not scheduled to be performed within the subsequent predetermined time period, control the communication unit to perform the HPLMN search for the first subscription.

16. The multi-SIM mobile communication device of claim 15, wherein the control unit is further configured to:
in response to determining that an HPLMN search for the second subscription is scheduled to be performed within the subsequent predetermined time period, control the communication unit to skip performing the HPLMN search for the first subscription.

17. The multi-SIM mobile communication device of claim 12, wherein the control unit is further configured to:
in response to determining that the mode capability of the first subscription is a subset of the mode capability of the second subscription, determine whether an HPLMN search for the second subscription was performed within a previous predetermined time period; and
in response to determining that an HPLMN search for the second subscription was performed within a previous predetermined time period, control the communication unit to skip performing the HPLMN search for the first subscription.

18. The multi-SIM mobile communication device of claim 17, wherein the control unit is further configured to:
in response to determining that an HPLMN search for the second subscription was not performed within a previous predetermined time period, determine whether an HPLMN search for the second subscription is scheduled to be performed within a subsequent predetermined time period; and
in response to determining that an HPLMN search for the second subscription is not scheduled to be performed within a subsequent predetermined time period, control the communication unit to perform the HPLMN search for the first subscription.

19. The multi-SIM mobile communication device of claim 18, wherein the control unit is further configured to:
in response to determining that an HPLMN search for the second subscription is scheduled to be performed within the subsequent predetermined time period,
control the communication unit to skip performing the HPLMN search for the first subscription.

20. The multi-SIM mobile communication device of claim 11, wherein the control unit is further configured to:
utilize results of the HPLMN search for the first subscription to identify an HPLMN for the second subscription.

21. A non-transitory computer readable medium having stored thereon instructions for causing one or more processors to perform operations comprising:
determining that a first subscription and a second subscription are roaming;
determining whether an HPLMN search timer has expired for the first subscription;
in response to determining that the HPLMN search timer has expired for the first subscription, determining whether a mode capability of the first subscription is greater than a mode capability of the second subscription;
in response to determining that the mode capability of the first subscription is greater than the mode capability of the second subscription, performing an HPLMN search for the first subscription; and
utilizing results of the HPLMN search for the first subscription to identify an HPLMN for the second subscription.

22. The non-transitory computer readable medium having stored therein instructions as defined in claim 21, the instructions further including:
in response to determining that the mode capability of the first subscription is not greater than the mode capability of the second subscription, determining whether the mode capability of the first subscription is a subset of the mode capability of the second subscription;
in response to determining that the mode capability of the first subscription is not a subset of the mode capability of the second subscription, determining whether the mode capability of the first subscription is equal to the mode capability of the second subscription; and
in response to determining that the mode capability of the first subscription is not equal to the mode capability of the second subscription, performing the HPLMN search for the first subscription.

23. The non-transitory computer readable medium having stored therein instructions as defined in claim 22, the instructions further including:
in response to determining that the mode capability of the first subscription is equal to the mode capability of the second subscription, determining whether data is enabled on the first subscription; and
in response to determining the data is enabled on the first subscription, performing the HPLMN search for the first subscription.

24. The non-transitory computer readable medium having stored therein instructions as defined in claim 23, the instructions further including:
in response to determining the data is not enabled on the first subscription, determining whether an HPLMN search for the second subscription was performed within a previous predetermined time period; and
in response to determining that an HPLMN search for the second subscription was performed within the previous predetermined time period, skipping performing the HPLMN search for the first subscription.

25. The non-transitory computer readable medium having stored therein instructions as defined in claim 24, the instructions further including:
in response to determining that an HPLMN search for the second subscription was not performed within the previous predetermined time period, determining whether an HPLMN search for the second subscription is scheduled to be performed within a subsequent predetermined time period; and
in response to determining that an HPLMN search for the second subscription is not scheduled to be performed within the subsequent predetermined time period, performing the HPLMN search for the first subscription.

26. The non-transitory computer readable medium having stored therein instructions as defined in claim 25, the instructions further including:
in response to determining that an HPLMN search for the second subscription is scheduled to be performed within the subsequent predetermined time period, skipping performing the HPLMN search for the first subscription.

27. The non-transitory computer readable medium having stored therein instructions as defined in claim 22, the instructions further including:
in response to determining that the mode capability of the first subscription is a subset of the mode capability of the second subscription, determining whether an HPLMN search for the second subscription was performed within a previous predetermined time period; and
in response to determining that an HPLMN search for the second subscription was performed within the previous predetermined time period, skipping performing the HPLMN search for the first subscription.

28. The non-transitory computer readable medium having stored therein instructions as defined in claim 27, the instructions further including:
in response to determining that an HPLMN search for the second subscription was not performed within the previous predetermined time period, determining whether an HPLMN search for the second subscription is scheduled to be performed within a subsequent predetermined time period; and
in response to determining that an HPLMN search for the second subscription is not scheduled to be performed within the subsequent predetermined time period, performing the HPLMN search for the first subscription.

29. The non-transitory computer readable medium having stored therein instructions as defined in claim 28, the instructions further including:
in response to determining that an HPLMN search for the second subscription is scheduled to be performed within the subsequent predetermined time period, skipping performing the HPLMN search for the first subscription.

30. A multi-subscriber identity module (SIM) mobile communication device, comprising:
means for determining that a first subscription and a second subscription are roaming;
means for determining whether an HPLMN search timer has expired for the first subscription;
in response to determining that the HPLMN search timer has expired for the first subscription, means for determining whether a mode capability of the first subscription is greater than a mode capability of the second subscription;
in response to determining that the mode capability of the first subscription is greater than the mode capability of the second subscription, means for performing an HPLMN search for the first subscription; and
means for utilizing results of the HPLMN search for the first subscription to identify an HPLMN for the second subscription.

31. The multi-SIM mobile communication device of claim 30, further comprising:
in response to determining that the mode capability of the first subscription is not greater than the mode capability of the second subscription, means for determining whether the mode capability of the first subscription is a subset of the mode capability of the second subscription;
in response to determining that the mode capability of the first subscription is not a subset of the mode capability of the second subscription, means for determining whether the mode capability of the first subscription is equal to the mode capability of the second subscription; and
in response to determining that the mode capability of the first subscription is not equal to the mode capability of the second subscription, means for performing the HPLMN search for the first subscription.

32. The multi-SIM mobile communication device of claim 31, further comprising:
in response to determining that the mode capability of the first subscription is equal to the mode capability of the second subscription, means for determining whether data is enabled on the first subscription; and
in response to determining the data is enabled on the first subscription, means for performing the HPLMN search for the first subscription.

33. The multi-SIM mobile communication device of claim 32, further comprising:
in response to determining the data is not enabled on the first subscription, means for determining whether an HPLMN search for the second subscription was performed within a previous predetermined time period; and
in response to determining that an HPLMN search for the second subscription was performed within the previous predetermined time period, means for skipping performing the HPLMN search for the first subscription.

34. The multi-SIM mobile communication device of claim 33, further comprising:
in response to determining that an HPLMN search for the second subscription was not performed within the previous predetermined time period, means for determining whether an HPLMN search for the second subscription is scheduled to be performed within a subsequent predetermined time period; and
in response to determining that an HPLMN search for the second subscription is not scheduled to be performed within the subsequent predetermined time period, means for performing the HPLMN search for the first subscription.

35. The multi-SIM mobile communication device of claim 34, further comprising:
in response to determining that an HPLMN search for the second subscription is scheduled to be performed within the subsequent predetermined time period, means for skipping performing the HPLMN search for the first subscription.

36. The multi-SIM mobile communication device of claim 31, further comprising:
in response to determining that the mode capability of the first subscription is a subset of the mode capability of the second subscription, means for determining whether an HPLMN search for the second subscription was performed within a previous predetermined time period; and
in response to determining that an HPLMN search for the second subscription was performed within the previous predetermined time period, means for skipping performing the HPLMN search for the first subscription.

37. The multi-SIM mobile communication device of claim 36, further comprising:
in response to determining that an HPLMN search for the first subscription or the second subscription was not performed within a previous predetermined time period, means for determining whether an HPLMN search for the second subscription is scheduled to be performed within a subsequent predetermined time period; and
in response to determining that an HPLMN search for the second subscription is not scheduled to be performed within a subsequent predetermined time period, means for performing the HPLMN search for the first subscription.

38. The multi-SIM mobile communication device of claim 37, further comprising:
in response to determining that an HPLMN search for the second subscription is scheduled to be performed within a subsequent predetermined time period, means for skipping performing the HPLMN search for the first subscription.
